(19) United States
(12) Patent Application Publication
(10) Pub. No.: US 2014/0326377 A1
(43) Pub. Date: Nov. 6, 2014

(54) TYRE HAVING A TREAD COMPRISING A FELT

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: Vincent Abad, Clermont-Ferrand Cedex 9 (FR); Emmanuel Custodero, Clermont-Ferrand Cedex 9 (FR)

(73) Assignee: Michelin Recherche et Technique S.A., GRANGES-PACCOT (CH)

(21) Appl. No.: 14/365,703

(22) PCT Filed: Dec. 14, 2012
(86) PCT No.: PCT/EP2012/075637

§ 371 Date: Jun. 16, 2014

(30) Foreign Application Priority Data
Dec. 16, 2011 (FR) 1161753

(51) Int. Cl. B60C 11/14; B60C 1/00

(52) U.S. Cl. CPC B60C 11/14; B60C 1/0016; B60C 2011/145
USPC 152/209.4

(57) ABSTRACT

A tire is provided with a tread that includes a felt. Fibers of the felt are fibers selected from a group that includes: textile fibers, inorganic fibers, and mixtures of textile fibers and inorganic fibers.

The present invention relates to tires provided with a tread.

An ongoing objective of tire manufacturers is to improve the wet grip of tires without damaging the performance of the tires, such as the behavior, the wear resistance and the rolling resistance.

In order to obtain a satisfactory running performance, in particular on wet road surfaces, it is known practice to provide a tread of a tire with a tread pattern formed of tread pattern elements separated from one another by indentations (grooves with a mean width of greater than or equal to 2 mm and/or sipes with a mean width of less than 2 mm), these indentations being obtained, for example, by molding. The tread pattern elements thus formed comprise a contact face intended to come into contact with the road surface during running and lateral faces also delimiting the indentations; the intersection of each lateral face with the contact face forms an edge corner facilitating contact between the tire and the road surface, in particular when the road surface is wet. More generally, an edge corner is defined as the geometric limit of contact of a tread pattern element with the ground during running.

With tread pattern elements, a distinction is made between elements which do not go all the way around the tire (blocks) and elements which do go all the way around the tire (ribs). Moreover, the tread pattern elements can comprise one or more sipes in order to form additional edge corners, it being or not being possible for each sipe to emerge on at least one lateral face of the tread pattern element. By definition, a sipe is the space delimited by two opposing main faces separated from one another by a width of less than 2 mm.

### BRIEF DESCRIPTION OF THE INVENTION

A subject-matter of the invention is a tire comprising a tread, characterized in that at least a portion of the tread pattern elements of the tread is composed of felt and in that the fibers of the felt are fibers selected from the group of textile fibers, inorganic fibers and their mixtures.

The Applicant Company has discovered, very surprisingly, that the presence of such tread pattern elements made of felt in contact with a wet running ground makes it possible to substantially improve the grip of the tread on this wet ground.

According to a first embodiment, the felt elements of the tread emerge radially on the outside to constitute a portion of the contact faces of the tread pattern elements of the tread of the tire.

Advantageously, the felt elements can constitute the contact faces of at least a portion of a circumferential rib of the tread.

According to another embodiment, the felt elements can constitute the contact faces of at least one assembly of tread pattern elements which are positioned axially.

Advantageously, the apparent density of the felt is greater than 0.15 and preferably 0.25. Below 0.15, the cohesion of the felt becomes insufficient for application in a tire tread.

The invention relates more particularly to the tires intended to equip non-motor vehicles, such as bicycles, or motor vehicles of passenger vehicle type, SUVs (“Sport Utility Vehicles”), two-wheel vehicles (in particular motorcycles), aircraft, as well as industrial vehicles chosen from vans, “heavy-duty” vehicles—that is to say, underground trains, buses, heavy road transport vehicles (lorries, tractors, trailers) or off-road vehicles, such as heavy agricultural vehicles or earthmoving equipment—, or other transportation or handling vehicles.

### DETAILED DESCRIPTION OF THE INVENTION

In the present description, unless expressly indicated otherwise, all the percentages (%) shown are % by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The term “phr” is understood to mean parts by weight per hundred parts of elastomer.

The expression composition “based on” is understood to mean a composition comprising the mixture and/or the reaction product of the various constituents used, some of these base constituents being capable of reacting or intended to react with one another, at least in part, during the various phases of manufacture of the composition, in particular during the manufacture thereof and the crosslinking or vulcanization thereof.

### Measurements and Tests Used:

Measurement of the Coefficient of Friction

The measurements of coefficient of dynamic friction were carried out according to a method identical to that described by L. Busse, A. Le Gal and M. Küppel (Modelling of Dry and Wet Friction of Silica Filled Elastomers on Self-Affine Road Surfaces, Elastomer Friction, 2010, 51, p. 8). The test specimens are produced by molding, followed by vulcanization, of a square rubber support (50 mm×50 mm) with a thickness of 6 mm covered with felt with a thickness of 2 mm before curing. This thickness varies during the curing and reaches, by way of example, 1.4 mm in the case of the PLB40 felt from Laoureux. After closing the mold, the latter is placed in a press comprising heated platens at 150° C. for 50 minutes at a pressure of 16 bars. The ground used to carry out these measurements is a core withdrawn from a real road surface made of bituminous concrete of BBTM type (Standard NF P 98-137). In order to prevent phenomena of dewetting and the appearance of secondary grip forces between the ground and the material, the ground+test specimen system is immersed in a 5% aqueous solution of a surface-active agent (Sinnozon—CAS number: 25155-30-0). The temperature of the aqueous solution is regulated using a thermostatic bath. The test specimen is subjected to a sliding movement in translation parallel to the plane of the ground. The sliding rate SR is set at 0.03 m/sec. The normal stress applied σₙ is 100 kPa. These conditions are described below by “wet ground conditions”. The tangential stress σₜ, opposed to the movement of the test specimen over the ground, is measured continuously. The ratio of the tangential stress σₜ to the normal stress σₙ gives the coefficient of dynamic friction μ. The values shown in the table below are the values of coefficient of dynamic friction obtained under continuous operating conditions after stabilization of the value of the tangential stress σₜ.

### Felt

The tire according to the invention has the essential characteristic of comprising a tread with tread pattern elements or portions of tread pattern elements made of felt composed of fibers selected from the group of textile fibers, inorganic fibers and their mixtures.

The presence of these felt elements makes it possible to substantially improve the wet grip of the tire.

In that which follows, “felt” or “nonwoven” of fibers is understood to mean any manufactured product composed of a veil, of a web or of a mat of fibers, whether they are distributed directionally or by chance, the fibers of which are entangled or intermixed in three dimensions.

The methods of manufacture of such felts are well known, in particular by needling or padding.

The fibers of the felt can be selected from textile fibers of natural origin, for example, from the group of silk, cotton, bamboo, cellulose and wool fibers and their mixtures.

Examples of wool felts are the “PLB” and “MLB” felts from Laoureux. These felts are sold with an apparent density variable between 0.20 and 0.44.

The fibers of the felt can also be selected from the group of synthetic textile fibers, for example polyester, polyamide, carbon, aramid, polyethylene, polypropylene, polyacrylonitrile, polyimide, polysulphone, polyethersulphone, polyurethane and polyvinyl alcohol fibers and their mixtures.

The polyester fibers of the felt can advantageously be selected from the group of polyethylene terephthalate (PET—Dacron Invista Inc.) fibers, polybutylene terephthalate (PBT) fibers, polyethylene naphthalate (PEN) fibers and their mixtures.

Mention may be made, as example of felts composed of aramid fibers, of the felts produced with Nomex® (meta-aramid: poly(m-phenylene isophthalamide), fibers, having the abbreviation MPD-I) fibers from Du Pont de Nemours.

The fibers of the felt can also be selected from the group of inorganic fibers, for example glass fibers and basalt fibers.

The felts can be composed without distinction of several types of fibers from one and the same group or from different groups as described above.

### DESCRIPTION OF THE FIGURES

The appended figures illustrate embodiments of a tire tread incorporating a felt:

FIG. 1 exhibits a view in axial cross-section illustrating a first embodiment of a tread of a tire incorporating a felt;

FIG. 2 exhibits a second embodiment of a tread of a tire incorporating a felt;

FIG. 3 exhibits a third embodiment of a tread of a tire incorporating a felt;

FIG. 4 exhibits a fourth embodiment of a tread of a tire incorporating a felt;

FIG. 5 exhibits, in top view and highly diagrammatically, a portion of tread, several blocks of which incorporate a felt.

### EXAMPLES OF THE IMPLEMENTATION OF THE INVENTION

In the figures, axes X, Y and Z have been represented which are orthogonal to one another and which correspond to the normal circumferential (X), axial (Y) and radial (Z) orientations of a tire.

The term “substantially circumferential orientation” is understood to mean an average orientation which does not deviate by more than 5° from the circumferential direction X.

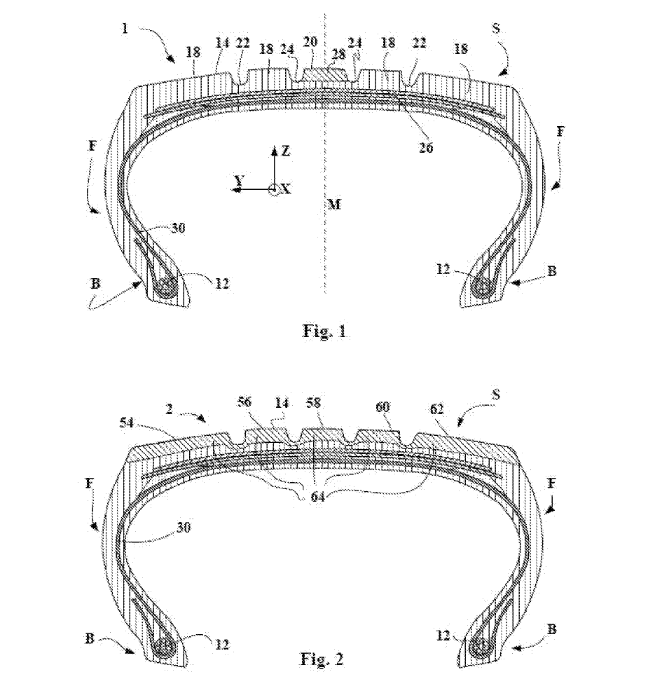

FIG. 1 depicts a tire according to one embodiment of the invention denoted by the general reference 1. Conventionally, the tire 10 comprises a crown S extended by two sidewalls F and two beads B.

Two bead wires 12 are embedded in the beads B. The two bead wires 12 are arranged symmetrically with respect to a median radial plane M of the tire.

Each bead wire 12 exhibits symmetry of revolution about a reference axis. This reference axis, substantially parallel to the direction Y, is substantially coincident with an axis of revolution of the tire.

The tire 1 also comprises a carcass reinforcement 30, the ends of which are wound around the bead wires 12. The carcass reinforcement in the example represented comprises one or more textile reinforcing plies oriented substantially radially.

The crown S comprises a tread 14 provided with tread patterns 18 and 20 separated by indentations or grooves 22 and 24, and also a normal crown reinforcement 26. The two grooves 24 surround the central tread pattern 20, which is a circumferential rib.

The radially outer part and the contact face of the circumferential rib 20 are composed of a felt 28 which extends circumferentially over the entire periphery of the tread of the tire.

FIG. 2 exhibits an axial cross-section of a tire 2 similar to that of FIG. 1 according to another embodiment of the invention. In this axial cross-section, all of the blocks or tread pattern elements 54, 56, 58, 60 and 62 of the tread 14 of the tire are composed of a felt 64. This felt extends axially and circumferentially over the whole of the crown of the tire. A rubber underlayer (not represented) can be positioned between the felt and the crown reinforcement.

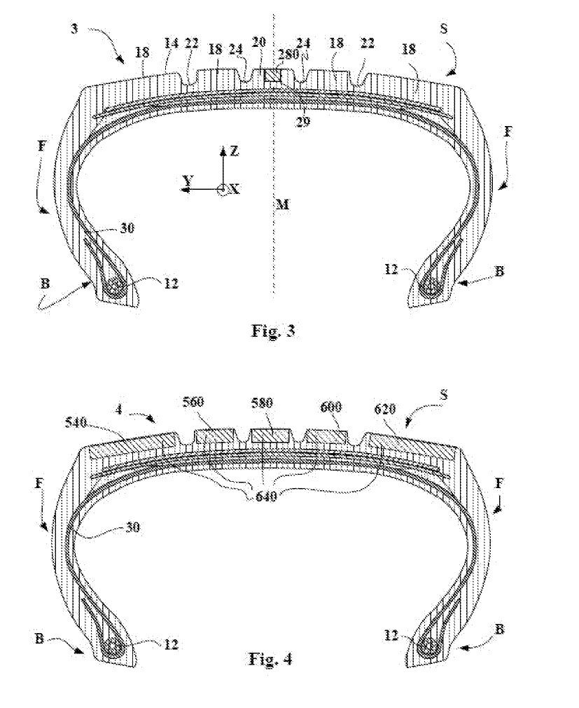

FIG. 3 exhibits an axial cross-section of a tire 3 similar to that of FIG. 1 according to another embodiment of the invention. In this embodiment, a cavity 29 is filled with a felt 280. The cavity 29 extends circumferentially in a continuous or non-continuous fashion.

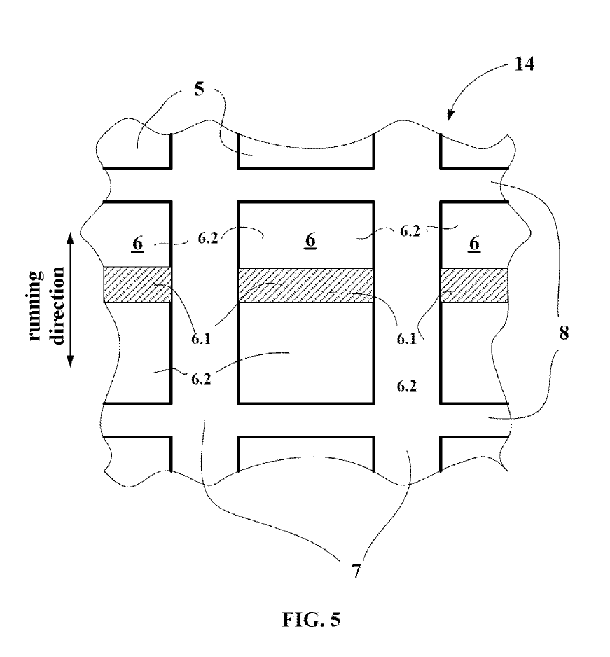

FIG. 4 exhibits an axial cross-section of a tire 4 similar to that of FIG. 2 according to another embodiment of the invention. The tread of this tire 4 comprises a plurality of cavities 540, 560, 580, 600 and 620 positioned in blocks placed axially with respect to one another. Each cavity is filled with a felt 640. The cavities extend circumferentially over a distance of between 5 and 30 mm. The number of cavities in the circumferential direction is of the order of 10 to 20. This number is such that, under normal running conditions, at least one axial assembly of blocks comprising cavities with felts is continuously in the contact area.

FIG. 5 is a partial and highly diagrammatic top view of a tread according to an embodiment similar to that of FIG. 4. The tread 14 comprises a running surface 5 and an assembly of blocks 6 which are delimited by circumferential grooves 7 and axial grooves 8. The blocks 6 comprise a felt 6.2 positioned between two rubber parts 6.1. In this embodiment and contrary to the embodiment illustrated in FIG. 4, the impregnated felts 6.2 constitute a portion of the side faces of the blocks 6.

The blanks of these tires are produced in the normal way by successive stacking of the different elements of the tire. The strips of felt can be positioned circumferentially or axially or also in cavities. The blank is then placed in the vulcanization mold and the molding of the tread is carried out conventionally during the closing of the mold, followed by the vulcanization of the blank.

### Trials

The coefficient of friction of test specimens composed, on the one hand, of a tire tread standard mixture and, on the other hand, of wool felt, reference PLB40 from Laoureux, was determined under the conditions described above. The results presented below are presented in base 100: an arbitrary value of 100 is given for the coefficient of friction of the control, a result greater than 100 indicating a better grip performance.

The composition of the tread control mixture (A) is presented in Table 1 below.

TABLE 1

| | A |
|---|---|
| Composition | (phr) |
| SBR (1) | 40 |
| SBR (2) | 60 |
| Silica (3) | 90 |
| Coupling agent (4) | 7.5 |
| Carbon black (5) | 4 |
| Liquid plasticizer (6) | 20 |
| Resin (7) | 20 |
| Antiozone wax | 1.5 |
| Antioxidant (8) | 2 |
| DPG (9) | 1.5 |
| ZnO (10) | 2.75 |
| Stearic acid (11) | 2 |
| CBS (12) | 2.1 |
| Sulphur | 1.4 |

(1) Solution SBR (contents expressed as dry SBR: 41% of styrene, 24% of 1,2-polybutadiene units and 51% of trans-1,4-polybutadiene units (Tg = −25° C.));
(2) Solution SBR (contents expressed as dry SBR: 29% of styrene, 5% of 1,2-polybutadiene units and 80% of trans-1,4-polybutadiene units (Tg = −56° C.));
(3) Silica (Zeosil 1165MP from Rhodia);
(4) TESTP coupling agent (Si69 from Degussa);
(5) Carbon black N234;
(6) TDAE oil, Vivatec 500, from Hansen & Rosenthal;
(7) C₅/C₉ Resin, Cray Valley Wingtack from STS;
(8) N-(1,3-Dimethylbutyl)-N-phenyl-para-phenylenediamine (Santoflex 6-PPD from Flexsys);
(9) DPG = Diphenylguanidine (Perkacit DPG from Flexsys);
(10) Zinc oxide (industrial grade - Umicore);
(11) Stearin (Pristerene from Uniqema);
(12) N-Cyclohexyl-2-benzothiazolesulphenamide (Santocure CBS from Flexsys).

The measurements of coefficient of dynamic friction were carried out under wet ground conditions, at a sliding rate of 0.03 m/s, under a normal pressure of 1 bar and at three temperatures (5, 25 and 45° C.). The results are presented in Table 2.

TABLE 2

| Temperature (° C.) | 5 | 25 | 45 |
|---|---|---|---|
| Control | 100 | 100 | 100 |
| Felt PLB40 | 109 | 126 | 177 |

The results presented in Table 2 demonstrate that the test specimens composed of pure wool felt make possible a significant improvement in the wet grip, particularly at high temperatures.

In the set of embodiments presented, the parts of the treads made of felt can thus be regarded as skid-resistant inserts.

1-10. (canceled)

11. A tire comprising a tread having tread pattern elements,
wherein at least a portion of the tread pattern elements of the tread includes felt elements composed of a material that includes felt, and
wherein the felt includes fibers selected from a group of fibers that includes: textile fibers, inorganic fibers, and mixtures thereof.

12. The tire according to claim 11, wherein the felt elements of the tread emerge radially on an outside portion of the tire and constitute a portion of contact faces of the tread pattern elements of the tread.

13. The tire according to claim 11, wherein the felt elements of the tread emerge radially on an outside portion of the tire and constitute a contact face of at least a portion of a circumferential rib of the tread.

14. The tire according to claim 12, wherein the felt elements of the tread emerge radially on an outside portion of the tire and constitute a contact face of at least a portion of a circumferential rib of the tread.

15. The tire according to claim 11, wherein the felt elements of the tread emerge radially on an outside portion of the tire and constitute contact faces of at least one group of tread pattern elements that are positioned axially.

16. The tire according to claim 11, wherein the fibers of the felt are selected from a group of fibers that includes: silk fibers, cotton fibers, cellulose fibers, bamboo fibers, wool fibers, and mixtures thereof.

17. The tire according to claim 16, wherein the fibers of the felt are wool fibers.

18. The tire according to claim 11, wherein the fibers of the felt are selected from a group of fibers that includes: polyamide fibers, aramid fibers, carbon fibers, polyethylene fibers, polypropylene fibers, polyacrylonitrile fibers, polyimide fibers, polysulphone fibers, polyethersulphone fibers, polyurethane fibers, polyvinyl alcohol fibers, polyester fibers, polyvinyl chloride fibers, and mixtures thereof.

19. The tire according to claim 18, wherein the fibers of the felt are polyester fibers selected from a group that includes: polyethylene terephthalate (PET) fibers, polybutylene terephthalate (PBT) fibers, polyethylene naphthalate (PEN) fibers, and mixtures thereof.

20. The tire according to claim 11, wherein the fibers of the felt are inorganic fibers selected from a group that includes: glass fibers and basalt fibers.

21. The tire according to claim 11, wherein an apparent density of the felt is greater than 0.15.

22. The tire according to claim 21, wherein an apparent density of the felt is greater than 0.25.
